(19) United States
(12) Patent Application Publication
(10) Pub. No.: US 2009/0009537 A1
(43) Pub. Date: Jan. 8, 2009

(54) Display unit and display panel driver including operational amplifier to apply reference voltage to resistance ladder having impedance adjusting circuit

(75) Inventor: Atsushi Shimatani, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/155,992

(22) Filed: Jun. 12, 2008

(30) Foreign Application Priority Data
Jul. 6, 2007 (JP) 2007-178858

(51) Int. Cl. G09G 5/10

(52) U.S. Cl. 345/690

(57) ABSTRACT

A display driver includes an operational amplifier which receives a gradation power source voltage and outputs a reference voltage, a resistance ladder which receives the reference voltage to generate a gradation voltage, and a resistor including a first end coupled to an output of the operational amplifier and a second end supplied with a voltage having the same potential as the reference voltage.

### BACKGROUND OF THE INVENTION

1. Field of the Invention

The present invention relates to a display unit and a display panel driver and in particular to a technology for generating a gradation voltage corresponding to each grade in gradation usable on a display panel.

2. Description of Related Art

In some cases, a gradation voltage generation -circuit is mounted on a display panel driver to drive a display panel such as a liquid crystal display panel by drive voltage. A gradation voltage generation circuit means a circuit that generates a gradation voltage corresponding to each grade in gradation usable on a display panel. In a typical display panel driver, a gradation voltage generated in a gradation voltage generation circuit is selected in accordance with pixel data showing the gradation of each pixel and each pixel is driven by the selected gradation voltage.

For example, Japanese Laid Open Patent Application No. 2002-258816 discloses a liquid crystal driver equipped with: a potential generation circuit to generate a γ voltage signal group (namely gradation voltages); an impedance converting circuit connected to the output of the potential generation circuit; and a liquid crystal drive circuit to convert an image data signal into an image signal on the basis of a γ voltage signal output from the impedance converting circuit. A D/A converter is used when a γ voltage signal is generated in the potential generation circuit. An operational amplifier is used in the impedance converting circuit.

FIG. 1 is a block diagram showing a typical configuration of a liquid crystal display unit to drive a liquid crystal display panel with an LCD (Liquid Crystal Display) driver on which a gradation voltage generation circuit is mounted. A liquid crystal display unit 100 shown in FIG. 1 includes a liquid crystal display panel 1, a gradation power source 2, an LCD driver 3, and a scanning line driver 4.

The liquid crystal display panel 1 includes data lines 5, scanning lines 6, and pixels 7 each of which is disposed at a place where a data line 5 intersects with a scanning line 6. Each pixel 7 includes a TFT (Thin Film Transistor) 8 and a pixel electrode 9a. Each pixel electrode 9a is disposed so as to face a common electrode 9b having common voltage V_{COM} and the space between the pixel electrode 9a and the common electrode 9b is filled with liquid crystal.

The gradation power source 2 supplies gradation power source voltages V_{E1} to V_{Em} to the LCD driver 3. The gradation power source voltages V_{E1} to V_{Em} are used for generating gradation voltages V₁ to Vₙ as will be described later.

The LCD driver 3 drives the data lines 5 in the liquid crystal display panel 1 in accordance with pixel data DIN showing the gradation of each pixel. More specifically, the LCD driver 3 includes a data register 11, a latch circuit 12, a gradation voltage generation circuit 113, a D/A converter 14, and an output circuit 15. The data register 11 receives and stores the pixel data D_{IN} showing the gradation of each pixel 7. The latch circuit 12 latches the pixel data D_{IN} from the data register 11 in response to a strobe signal ST and transfers the latched pixel data D_{IN} to the D/A converter 14. The gradation voltage generation circuit 113 generates the gradation voltages V₁to Vₙ from the gradation power source voltages V_{E1} to V_{Em} received from the gradation power source 2. The D/A converter 14 selects the gradation voltages V₁ to Vₙ in accordance with the pixel data D_{IN} received from the latch circuit 12 and outputs the selected gradation voltages to the output circuit 15. The output circuit 15 includes voltage followers (not shown in the figure) each of which is connected to each of the data lines 5 and drives each of the data lines 5 to a drive voltage corresponding to a gradation voltage supplied from the D/A converter 14.

The scanning line driver 4 drives the scanning lines 6 on the liquid crystal display panel 1 in sequence. When a data line 5 is driven in the state where a scanning line 6 is activated, a drive voltage is written in the pixel 7 connected to the activated scanning line 6 via the data line 5 and thereby the pixel 7 is driven.

FIG. 2 is a circuit diagram showing an example of a configuration of a gradation power source 2 and a gradation voltage generation circuit 113. The gradation power source 2 includes a constant-voltage generation circuit 21 and a resistance ladder 22. The constant-voltage generation circuit 21 supplies a prescribed voltage to both the ends of the resistance ladder 22. The resistance ladder 22 outputs gradation power source voltages V_{E1} to V_{Em} from the taps, respectively. The resistance ladder 22 is configured so that the resistance value between adjacent taps may be variable in order to make the gradation power source voltages V_{E1} to V_{Em} adjustable. The gradation power source voltages V_{E1} to V_{Em} are optimally adjusted in accordance with the characteristics of a liquid crystal display panel 1.

The gradation voltage generation circuit 113 includes operational amplifiers 23 and a gradation voltage generating resistance ladder 24. If necessary hereunder, then the operational amplifiers 23 may occasionally be distinguished from each other by adding subscripts to the reference numeral “23.” Each of the operational amplifiers 23₁ to 23ₘ functions as a follower to generate each of the reference voltages V_{S1} to V_{Sm} from each of the gradation power source voltages V_{E1} to V_{Em}. Although an operational amplifier 23ᵢ basically outputs a reference voltage V_{Si} identical to a gradation power source voltage V_{Ei}, it is also possible to fine-tune the reference voltage V_{Si} in some operations. The reference voltages V_{S1} to V_{Sm} are output to the input taps of the gradation voltage generating resistance ladder 24. The gradation voltage generating resistance ladder 24 accepts the supply of the reference voltages V_{S1} to V_{Sm} and generates the gradation voltages V₁ to Vₙ from the output taps. A resistance value between adjacent output taps is determined in accordance with the gamma-curve of the liquid crystal display panel 1.

Although a configuration wherein operational amplifiers 23 in a gradation voltage generation circuit 113 drive one gradation voltage generating resistance ladder 24 in an LCD driver 3 is shown in FIGS. 1 and 2, the configuration of a gradation power source 2 and a gradation voltage generation circuit 113 can be changed variously. For example, operational amplifiers 23 may not be incorporated in an LCD driver 3 but may be integrated into an exterior IC for exclusive use together with a constant-voltage generation circuit 21 and a resistance ladder 22. Further, as shown in FIG. 3, in some cases, the operational amplifiers 23₁ to 23ₘ are shared by plural LCD drivers 3 and the set of the operational amplifiers 23₁ to 23ₘ is used for driving plural gradation voltage generating resistance ladders 24. On this occasion, the operational amplifiers 23₁ to 23ₘ are integrated into plural LCD drivers in a distributed manner. FIG. 3 shows a case where two operational amplifiers 23₂ᵢ₋₁ and 23₂ᵢ are incorporated into a LCD driver 3ᵢ. The configuration of integrating operational amplifiers 23 into an LCD driver 3 is effective for reducing the cost. The configuration of integrating operational amplifiers 23 into an IC for exclusive use causes the numbers of the parts in a liquid crystal display unit 100 to increase and thus is not advantageous from the viewpoint of the cost.

Operational amplifiers 23 to drive a gradation voltage generating resistance ladder 24 have to be designed so as to be operated stably while not causing oscillation. One of the items that should be taken into consideration in order to secure stable operation is the magnitude of load on each of the operational amplifiers 23. The loads on the operational amplifiers 23 are determined by the resistance values of the gradation voltage generating resistance ladder 24 and the capacitances C_{P1} to C_{Pm} of wires connected to the outputs of the operational amplifiers 23. Consequently, the operational amplifiers 23 have to be designed appropriately in accordance with the resistance values of the gradation voltage generating resistance ladder 24 and the load capacitances C_{P1} to C_{Pm}. In the case where operational amplifiers 23 are incorporated into an LCD driver 3 in particular, a design that takes phase margins into consideration is important. This is because in general an operational amplifier comprising a CMOS has a less phase margin to a capacitive load.

As an operational amplifier to drive a gradation voltage generating resistance ladder, a two-stage amplifier is generally used and hence the stability of the operation of a two-stage amplifier shown in FIG. 4 is hereunder discussed. The two-stage amplifier shown in FIG. 4 includes an input stage 31, an output stage 32, and a feedback capacitor 33 to connect the output of the output stage 32 to the input.

When a mutual conductance of the input stage 31 is represented with gₘ₁, an output resistance thereof R₁, an output capacitance thereof C₁, a mutual conductance of the output stage 32 gₘ₂, an output resistance thereof R₂, an output capacitance thereof C₂, a load resistance of the two-stage amplifier R_{L}, a load capacitance thereof C_{L}, and a capacitance of the feedback capacitor 33 C_{C}, the characteristics of the two-stage amplifier shown in FIG. 4 are represented with a small signal equivalent circuit shown in FIG. 5. From the small signal equivalent circuit, the frequency response characteristic of the two-stage amplifier is obtained as follows:

$$\begin{matrix}[ Expression 1 ] & \\ \begin{matrix}Av = \frac{vo}{v 1} , \\ = \frac{{g}_{m 1} \cdot {g}_{m 2} \cdot {R}_{1} \cdot ( {R}_{2} // {R}_{L} ) ( 1 - s \frac{{C}_{C}}{{g}_{ms}} )}{D ( s )} ,\end{matrix} & ( 1 )\end{matrix}$$

Here, D(s) is the denominator of a transfer function and is expressed with the following formula:

[Expression 2]

D(s)=1+{R₁(C₁+C_{C})+(R₂//R_{L})(C₂+C_{L}+C_{C})+C_{C}·R₁(R₂//R_{L})gₘ₂}s+[{C₁(C₂+C_{L})+C₁·C_{C}+(C₂+C_{L})·C_{C}·R₁·(R₂//R_{L})]s². (2)

The denominator D(s) of the Expression 2 is, when a first pole is represented with p₁ and a second pole with p₂, expressed with the following formula:

$$\begin{matrix}[ Expression 3 ] & \\ \begin{matrix}D ( s ) = ( 1 - \frac{s}{{p}_{1}} ) \cdot ( 1 - \frac{s}{{p}_{2}} ) , \\ = 1 - ( \frac{1}{{p}_{1}} + \frac{1}{{p}_{2}} ) \cdot s + \frac{1}{{p}_{1} \cdot {p}_{2}} \cdot {s}^{2} .\end{matrix} & ( 3 )\end{matrix}$$

Here, the poles p₁ and p₂ have the following relational expressions;

$$\begin{matrix}[ Expressions 4 a and 4 b ] & \\ p 1 + p 2 = - p 1 \cdot p 2 \cdot \{ {R}_{1} ( {C}_{1} + {C}_{2} ) + ( {R}_{2} // {R}_{L} ) ( {C}_{2} + {C}_{L} + {C}_{C} ) + {C}_{C} \cdot {R}_{1} ( {R}_{2} // {R}_{L} ) {g}_{m 2} \} = α , & ( 4 a ) \\ p 1 \cdot p 2 = \frac{1}{\{ {C}_{1} ( {C}_{2} + {C}_{L} ) + {C}_{1} \cdot {C}_{C} + ( {C}_{2} + {C}_{L} ) \cdot {C}_{C} \} \cdot {R}_{1} \cdot ( {R}_{2} // {R}_{L} )} . & ( 4 b )\end{matrix}$$

On this occasion, the poles p₁ and p₂ are the solutions of the quadratic equation x²−ax+b=0.

FIG. 6 is a Bode diagram showing the frequency response characteristic of a two-stage amplifier in the case where parameters are set as follows.

C_{C}=1 Pf, C₁=200 fF, C₂=200 fF, R₁=35 MΩ, R₂=1.5 MΩ, g₁=20 μS, gₘ₁=150 μS, C_{L}=0.1 μF, R_{L}=100 Ω or 1 kΩ

The phase angle is −45° at a frequency corresponding to the pole p₁ and −135° at a frequency corresponding to the pole p₂. Consequently, it is possible to secure a sufficient phase margin when the frequency corresponding to the pole p₂ is close to or lower than the frequency that takes a gain of 0 dB. It should be noted that the phase margin is the difference between a phase angle at a frequency that takes a gain of 0 dB and the angle of 180°. As it is understood from the comparison between the case where the load resistance R_{L} is 100 Ω and the case where the load resistance R_{L} is 1 kΩ (refer to FIG. 6), the two-stage amplifier is operated more stably without oscillation as the load resistance R_{L} of the two-stage amplifier decreases. This means that, when a two-stage amplifier is applied to an operational amplifier 23, the operational amplifier 23 is operated more stably as the resistance value of a gradation voltage generating resistance ladder 24 decreases.

A problem of the gradation voltage generation circuit 113 shown in FIG. 2 is that an operational amplifier 23 is poor in versatility especially when the operational amplifier 23 is incorporated into an LCD driver 3. It is difficult to use an operational amplifier 23 designed for a liquid crystal display unit having a certain configuration for another liquid crystal display unit having a different configuration. This is because an operational amplifier 23 particularly mounted on an LCD driver (namely comprising a CMOS) cannot sufficiently cope with the change of load when the load on the operational amplifier 23 is changed in accordance with the configuration of the liquid crystal display unit. In the case of the configuration of the gradation voltage generation circuit 113 shown in FIG. 2, it is necessary to change the design of an operational amplifier 23 in accordance with the change of the load on the operational amplifier 23 from the viewpoint of operational stability.

For example, resistance values of a gradation voltage generating resistance ladder 24 have to be determined in conformity with the gamma-curve of a liquid crystal display panel 1 and hence are changed in accordance with the kind of the liquid crystal display panel 1. When a resistance value of a gradation voltage generating resistance ladder 24 is changed, the design of an operational amplifier 23 has to be changed in order to change the load on the operational amplifier 23.

Further, the load capacitances of operational amplifiers 23 are largely different between the case where the operational amplifiers 23 drive only a gradation voltage generating resistance ladder 24 incorporated into an identical LCD driver 3 as shown in FIG. 2 and the case where the operational amplifiers 23 drive gradation voltage generating resistance ladders 24 incorporated into separate LCD drivers 3 as shown in FIG. 3. More specifically, in the case where operational amplifiers 23 drive only a gradation voltage generating resistance ladder 24 incorporated into an identical LCD driver 3, the load capacitances of the operational amplifiers 23 are in the order of pF since they are composed of only the parasitic capacitances in the interior of the LCD driver 3. In contrast, in the case where operational amplifiers 23 drive gradation voltage generating resistance ladders 24 incorporated into all the LCD drivers 3 mounted on a liquid crystal display unit 100, the load capacitances of the operational amplifiers 23 may reach the order of μF since bypath condensers are sometimes connected to wires distributing reference voltages V_{S1} to V_{Sm} to the LCD drivers 3.

In this way, since the frequency response characteristic of an operational amplifier 23 largely depends on the load on the operational amplifier 23, when the load on the operational amplifier 23 is changed due to the change of the configuration of a liquid crystal display unit 100, the design of the operational amplifier 23 also has to be changed. This is not desirable from the viewpoint of economical efficiency.

### SUMMARY OF THE INVENTION

A display unit according to the present invention includes a display panel, operational amplifiers to receive gradation power source voltages and output reference voltages corresponding to the gradation power source voltages, a resistance ladder to be connected to the outputs of the operational amplifiers and generate plural gradation voltages from the reference voltages, and drive circuits to select gradation voltages corresponding to pixel data from the plural gradation voltages and drive the data lines of the display panel with the selected gradation voltages. Impedance adjusting circuits are connected to the outputs of the operational amplifiers.

In a display unit having such a configuration, since impedance adjusting circuits are connected to the outputs of operational amplifiers in parallel with a resistance ladder, the variations of the loads on the operational amplifiers are small even when the resistance values of the resistance ladder are changed in accordance with the change in the design of the display unit. Likewise, the variations of loads caused by the change of the capacitances of wires that connect the operational amplifiers to the resistance ladder are also small. In this way, in the display unit, since the variations of the loads on the operational amplifiers caused by the change in the design of the display unit are small, the versatility of the operational amplifiers can be enhanced.

The present invention makes it possible to enhance the versatility of operational amplifiers that drive a gradation voltage generating resistance ladder to generate gradation voltages.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a block diagram showing a configuration of a liquid crystal display unit of a related art;

FIG. 2 is a block diagram showing a configuration of a gradation voltage generation circuit mounted on a conventional liquid crystal display unit;

FIG. 3 is a circuit diagram showing another configuration of a conventional liquid crystal display unit;

FIG. 4 is a block diagram showing a configuration of a two-stage amplifier;

FIG. 5 is a view showing a small signal equivalent circuit of a two-stage amplifier;

FIG. 6 is a Bode diagram showing a frequency response characteristic of a two-stage amplifier;

FIG. 7 is a block diagram showing a configuration of a liquid crystal display unit according to an exemplary embodiment of the present invention;

FIG. 8 is a circuit diagram showing a configuration of a gradation voltage generation circuit according to the first exemplary embodiment; and

FIG. 9 is a circuit diagram showing a configuration of a gradation voltage generation circuit according to the exemplary second embodiment.

### DETAILED DESCRIPTION OF THE EXEMPLARY EMBODIMENTS

### First Embodiment

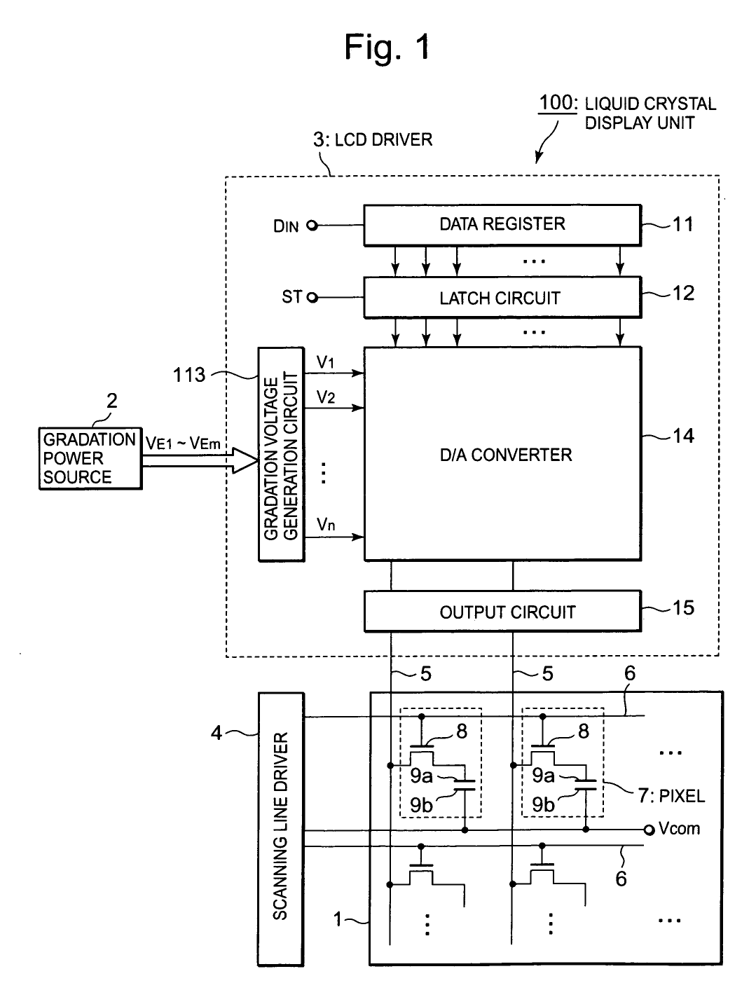

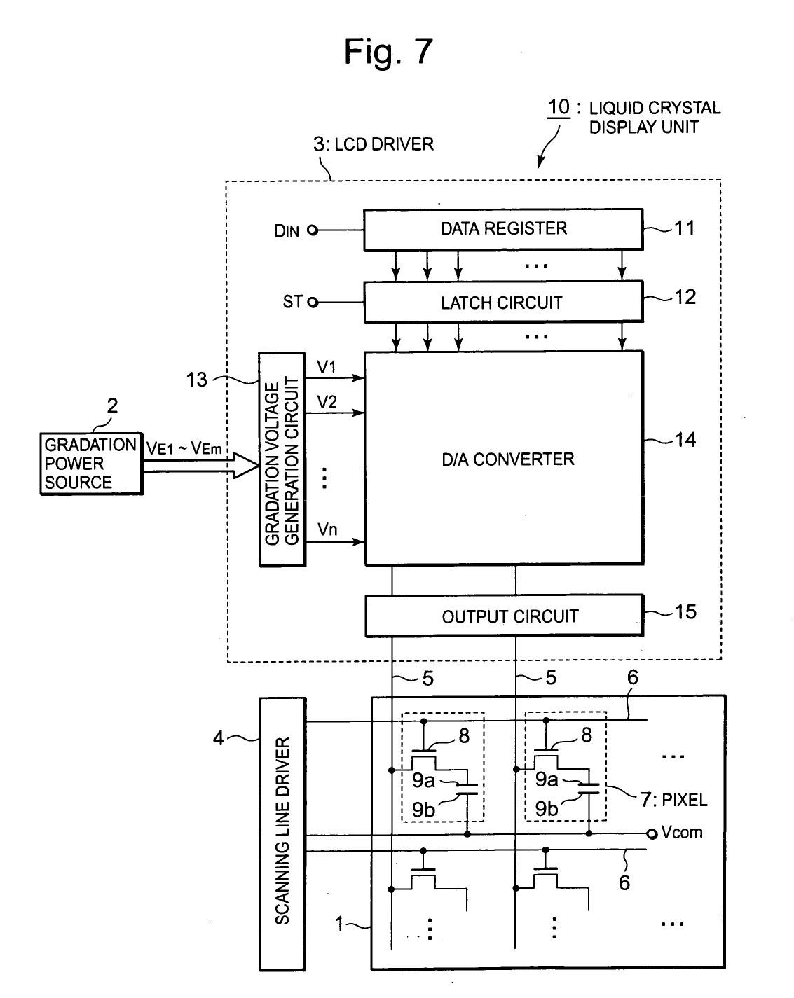

FIG. 7 is a block diagram showing an exemplary configuration of a liquid crystal display unit 10 according to the first exemplary embodiment of the present invention. The liquid crystal display unit 10 has a configuration similar to that of a conventional liquid crystal display unit 100 shown in FIG. 1, but the configuration of the gradation voltage generation circuit in the present embodiment is different from that in the conventional case.

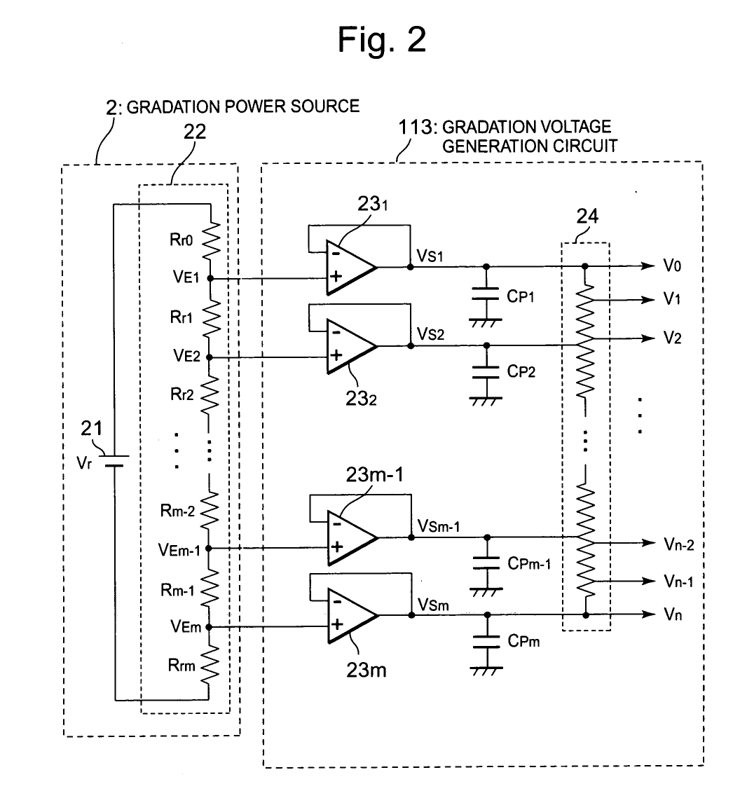

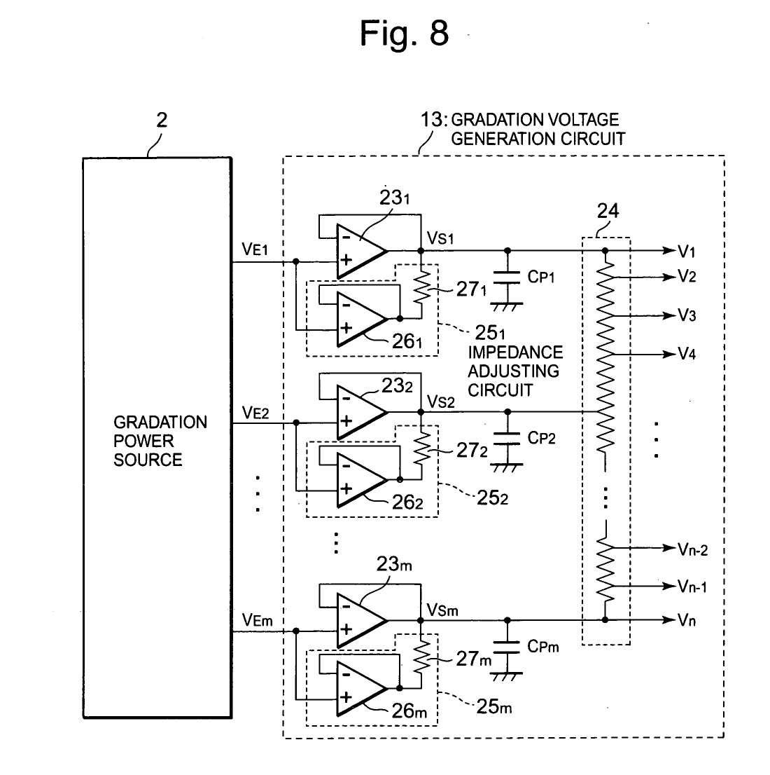

FIG. 8 is a circuit diagram showing an exemplary configuration of a gradation voltage generation circuit 13 mounted on the liquid crystal display unit 10. The gradation voltage generation circuit 13 includes operational amplifiers 23₁ to 23ₘ and a gradation voltage generating resistance ladder 24 in the same way as the gradation voltage generation circuit 113 shown in FIG. 2. The operational amplifiers 23₁ to 23ₘ function as voltage followers to generate reference voltages V_{S1} to V_{Sm} from gradation power source voltages V_{E1} to V_{Em}, respectively. The gradation voltage generating resistance ladder 24 accepts the supply of the reference voltages V_{S1} to V_{Sm} and generates gradation voltages V₁ to Vₙ from the output taps.

In addition, the gradation voltage generation circuit 13 includes impedance adjusting circuits 25₁ to 25ₘ connected to the outputs of the operational amplifiers 23₁ to 23ₘ, respectively. The impedance adjusting circuits 25₁ to 25ₘ may generically be named an impedance adjusting circuit 25 hereunder when they are not distinguished from each other. The impedance adjusting circuit 25 may be a circuit to regulate the load impedances of the operational amplifiers 23. The impedance adjusting circuit 25 functions as the load on the operational amplifiers 23 connected in parallel with the gradation voltage generating resistance ladder 24.

In the present embodiment, an impedance adjusting circuit 25ᵢ includes a holding amplifier 26ᵢ and an impedance adjusting resistance 27ⁱ. The input of the holding amplifier 26ⁱ is commonly connected to the input of an operational amplifier 23ⁱ and the output thereof is connected to the impedance adjusting resistance 27ⁱ. The impedance adjusting resistance 27ⁱ is connected to the output of the operational amplifier 23ⁱ and the output of the holding amplifier 26ⁱ.

When the gradation power source voltages V_{E1} to V_{Em} are supplied from the gradation power source 2, the operational amplifiers 23₁ to 23ₘ output the reference voltages V_{S1} to V_{Sm} identical to the gradation power source voltages V_{E1} to V_{Em}, respectively. At the same time, the holding amplifiers 26₁ to 26ₘ also output the voltages identical to the gradation power source voltages V_{E1} to V_{Em}, respectively. As a result, the output of an operational amplifier 23ᵢ is connected to a holding amplifier 26ⁱ in the state of zero potential via an impedance adjusting resistance 27ⁱ. As a result, the operational amplifier 23ⁱ drives the impedance adjusting resistance 27ⁱ, in addition to the gradation voltage generating resistance ladder 24 and a load capacitance C_{Pi}, as the load. The input taps of the gradation voltage generating resistance ladder 24 are driven by the reference voltages V_{S1} to V_{Sm} with the operational amplifiers 23₁ to 23ₘ and the gradation voltages V₁ to Vₙ are generated at the output taps of the gradation voltage generating resistance ladder 24.

In such a configuration, the variations of the loads on the operational amplifiers 23₁ to 23ₘ are small even when the resistance values of the gradation voltage generating resistance ladder 24 are changed. This is because the impedance adjusting resistance 27ᵢ is connected to the output of the operational amplifier 23ᵢ in parallel with the gradation voltage generating resistance ladder 24. For example, the case where the impedance adjusting resistance 27ᵢ is 100 Ω and the resistance value of the gradation voltage generating resistance ladder 24 outputted to the operational amplifier 23ᵢ is changed from 100 Ω to 1 kΩ is considered. When the impedance adjusting resistance 27ᵢ is not connected, the load resistance of the operational amplifier 23ᵢ changes by 900 Ω. On the other hand, when the impedance adjusting resistance 27ᵢ is connected, the load resistance of the operational amplifier 23ᵢ changes only by 41 Ω. In this way, the variation of the load on the operational amplifier 23ᵢ is suppressed because the impedance adjusting resistance 27ᵢ is connected to the output of the operational amplifier 23ᵢ in parallel with the gradation voltage generating resistance ladder 24.

That the impedance adjusting resistance 27ᵢ is connected in parallel with the gradation voltage generating resistance ladder 24 also contributes to the reduction of the load resistance of the operational amplifier 23ᵢ and the stabilization of the operation of the operational amplifier 23ᵢ. As stated above, the operation of the operational amplifier 23ᵢ is more stabilized as the load resistance thereof reduces.

Likewise, it can easily be understood by those skilled in the art that, in the case of a liquid crystal display unit 10 according to the present embodiment, the variations of the loads on the operational amplifiers 23₁ to 23ₘ are small even when the capacitances Cₚ₁ to Cₚₘ of wires connected to the outputs of the operational amplifiers 23₁ to 23ₘ are changed in accordance with the change of the configuration of the liquid crystal display unit 10.

In this way, in a liquid crystal display unit 10 according to the present embodiment, the variations of the loads on the operational amplifiers 23₁ to 23ₘ are small even when the configuration of the liquid crystal display unit 10 is changed. This makes it possible to reduce the design margin to the variations of the loads on the operational amplifiers 23₁ to 23ₘ and enhances the versatility of the operational amplifiers 23₁ to 23ₘ.

### Second Embodiment

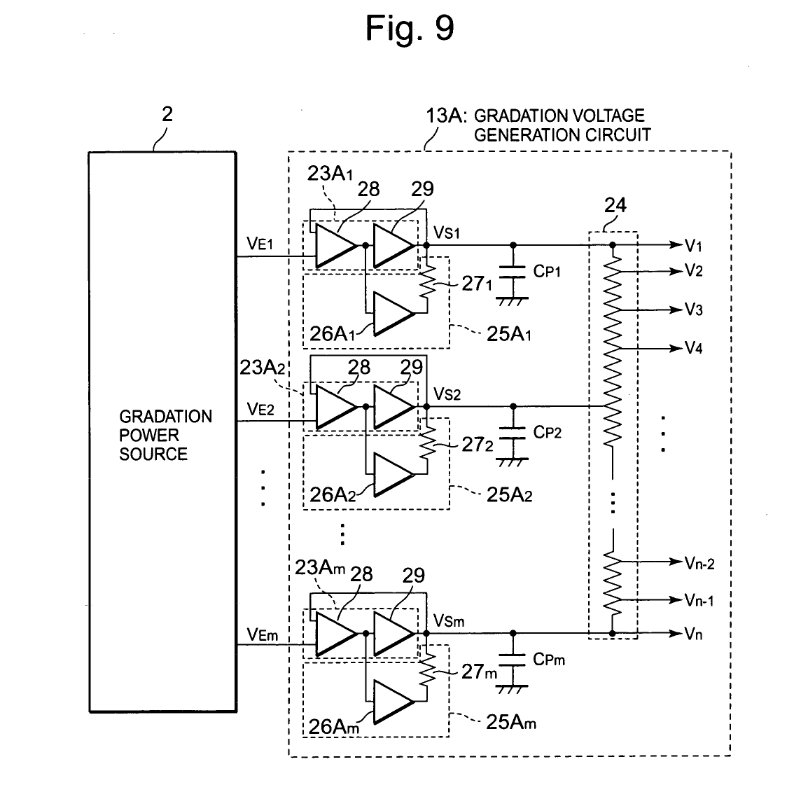

In the second exemplary embodiment, the configuration of a gradation voltage generation circuit is changed. FIG. 9 is a circuit diagram showing an exemplary configuration of a gradation voltage generation circuit 13A mounted on a liquid crystal display unit according to the second embodiment of the present invention. The gradation voltage generation circuit 13A according to the second embodiment is different from a gradation voltage generation circuit according to the first embodiment in terms of the configuration of operational amplifiers and the connection relation between the operational amplifiers and the impedance adjusting circuits.

More specifically, the gradation voltage generation circuit 13A includes operational amplifiers 23A₁ to 23Aₘ, a gradation voltage generating resistance ladder 24, and impedance adjusting circuits 25A₁ to 25Aₘ. As the operational amplifiers 23A₁ to 23Aₘ, two-stage amplifiers are used. That is, each of the operational amplifiers 23A₁ to 23Aₘ includes an input stage 28 and an output stage 29. The operational amplifiers 23A₁ to 23Aₘ function as voltage followers to generate reference voltages V_{S1} to V_{Sm} from gradation power source voltages V_{E1} to V_{Em}, respectively. The gradation voltage generating resistance ladder 24 accepts the supply of the reference voltages V_{S1} to V_{Sm} and generates gradation voltages V₁ to Vₙ from the output taps thereof.

In the present embodiment, the impedance adjusting circuits 25A₁ to 25Aₘ are connected between the outputs of the input stages 28 (namely, the inputs of the output stages 29) of the operational amplifiers 23A₁ to 23Aₘ and the outputs of the output stages 29. More specifically, an impedance adjusting circuit 25Aᵢ includes a holding amplifier 26Aᵢ and an impedance adjusting resistance 27Aᵢ. The input of the holding amplifier 26Aᵢ is connected to the output of the input stage 28 of an operational amplifier 23Aᵢ and the output of the holding amplifier 26Aᵢ is connected to the impedance adjusting resistance 27Aᵢ. The impedance adjusting resistance 27Aᵢ is connected between the output of the holding amplifier 26Aᵢ and the output of the output stage 29 of the impedance adjusting circuit 25Aᵢ.

In such a configuration too, the variations of the loads on operational amplifiers 23A₁ to 23Aₘ caused by the change of the configuration of a liquid crystal display unit 10 are small. That is, the variations of the loads on the operational amplifiers 23A₁ to 23Aₘ are small even when the resistance values of a gradation voltage generating resistance ladder 24 or the capacitances of the wires connected to the operational amplifiers 23A₁ to 23Aₘ are changed. This makes it possible to reduce the design margin to the variations of the loads on the operational amplifiers 23A₁ to 23Aₘ and enhances the versatility of the operational amplifiers 23Aᵢ to 23Aₘ.

In addition, in the configuration shown in FIG. 9, input stages 28 of operational amplifiers 23Aᵢ to 23Aₘ function also as input stages of holding amplifiers 26A₁ to 26Aₘ and hence it is possible to simplify the configuration of the holding amplifiers 26A₁ to 26Aₘ.

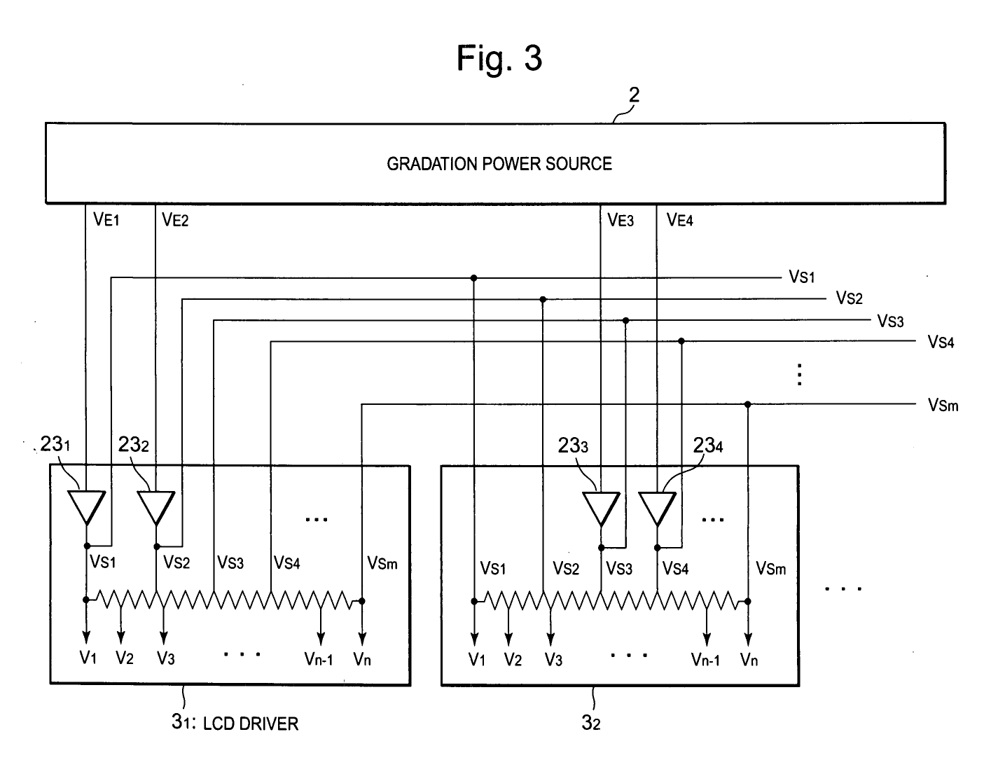

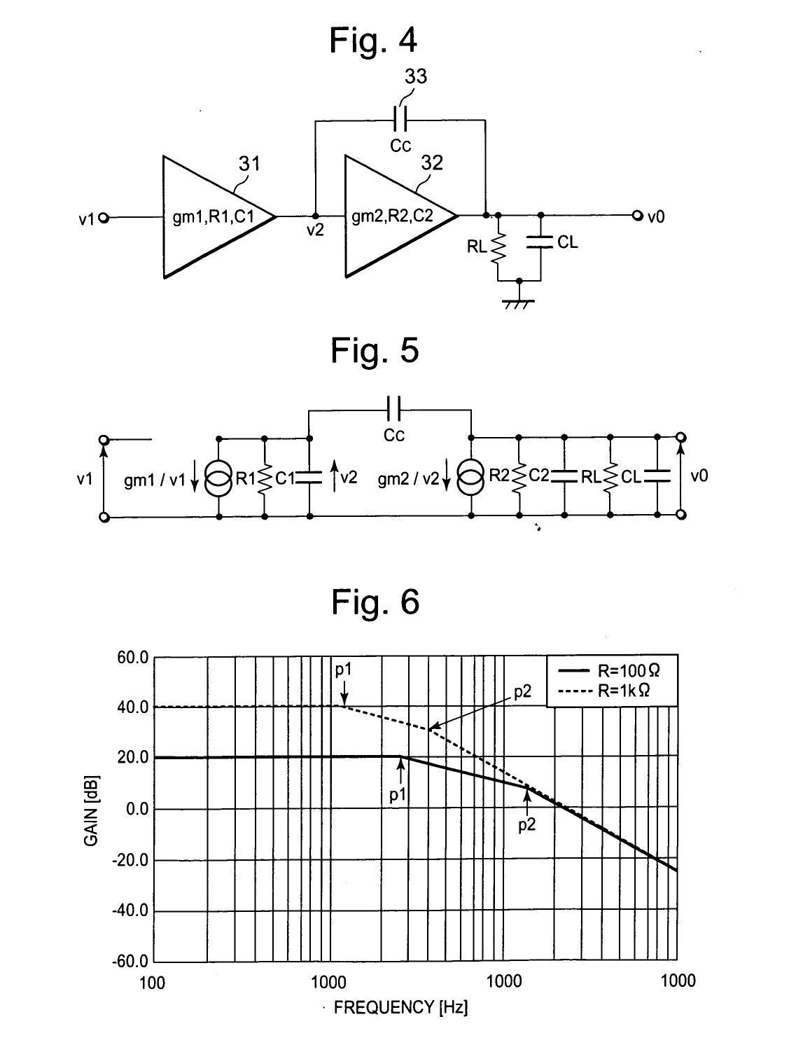

Here, although the configuration wherein all operational amplifiers 23 in a gradation voltage generation circuit 13 drive a gradation voltage generating resistance ladder 24 in one LCD driver 3 is shown in the above embodiment, the configuration of a gradation power source 2 and a gradation voltage generation circuit 13 can variously be modified. For example, in the same way as the liquid crystal display unit shown in FIG. 3, the operational amplifiers 23₁ to 23ₘ and the impedance adjusting circuits 25₁ to 25ₘ according to the first embodiment may be shared with plural LCD drivers 3 and a set of the operational amplifiers 23₁ to 23₁ and the impedance adjusting circuits 25₁ to 25ₘ may be used in order to drive plural gradation voltage generating resistance ladders 24 in some cases. On this occasion, the operational amplifiers 23₁ to 23ₘ and the impedance adjusting circuits 25₁ to 25ₘ are integrated into plural LCD drivers 3 in a dispersed manner. The same is applied to the operational amplifiers 23Aᵢ to 23Aₘ and the impedance adjusting circuits 25A₁ to 25Aₘ according to the first embodiment.

Further, although a liquid crystal display unit to display images on a liquid crystal display panel is proposed in the above exemplary embodiments, it will be obvious to those skilled in the art that the present invention is versatilely applicable also to a display unit on which a display panel driven by voltage is mounted.

Further, it is noted that Applicant's intent is to encompass equivalents of all claim elements, even if amended later during prosecution.

What is claimed is:

1. A display unit, comprising:
a display panel including a plurality of data lines;
a plurality of operational amplifiers which receive gradation power source voltages, and output a plurality of reference voltages corresponding to the gradation power source voltages;
a resistance ladder, connected to outputs of the operational amplifiers, to generate a plurality of gradation voltages from the reference voltages, a selected gradation voltage of said plurality of gradation voltages corresponding to a pixel data being transferred to a corresponding one of said plurality of data lines of said display panel; and
a plurality of impedance adjusting circuits coupled to the respective operational amplifiers.

2. The display unit according to claim 1, wherein each of the impedance adjusting circuits includes:
a holding amplifier having an input coupled to an input of the respective operational amplifier; and
a resistance element coupled between the holding amplifier and an output of the respective operational amplifier.

3. The display unit according to claim 1, wherein each of the operational amplifiers includes:
an input stage which receives the respective gradation power source voltage; and
an output stage which coupled to an output of the input stage and which outputs the respective reference voltage, and
wherein each of the impedance adjusting circuits includes:
a holding amplifier including an input coupled to the output of the input stage; and
a resistance element coupled between an output of the holding amplifier and the output of the output stage.

4. The display unit according to claim 1, wherein the operational amplifiers are integrated into a display panel driver.

5. A display panel driver comprising:
a plurality of operational amplifiers which receive gradation power source voltages and which output a plurality of reference voltages corresponding to the gradation power source voltages;
a resistance ladder, connected to outputs of the operational amplifiers, to generate a plurality of gradation voltages from the reference voltages, a selected gradation voltage of said plurality of gradation voltages corresponding to a pixel data being transferred to a display panel to drive a corresponding one of a plurality of data lines of the display panel; and
a plurality of impedance adjusting circuits coupled to the respective operational amplifiers.

6. A display driver, comprising:
an operational amplifier which receives a gradation power source voltage and which outputs a reference voltage;
a resistance ladder which receives said reference voltage to generate a gradation voltage; and
a resistor including a first end coupled to an output of said operational amplifier and a second end supplied with a voltage having a same potential as said reference voltage.

7. The display driver as claimed in claim 6, further comprising:
an amplifier coupled between an input of said operational amplifier and said second end of said resistor.

8. The display driver as claimed in claim 6,
wherein said operational amplifier comprises:
an input stage which receives the gradation power source voltage; and
an output stage which is coupled to an output of the input stage and outputs the reference voltage,
said display driver further comprising:
an amplifier coupled between said output of said input stage and said second end of said resistor.
